(19) United States
(12) Patent Application Publication
(10) Pub. No.: US 2022/0055220 A1
(43) Pub. Date: Feb. 24, 2022

(54) ASSEMBLING APPARATUS AND METHOD FOR ADJUSTING THE SAME

(71) Applicant: NALUX CO., LTD., Osaka (JP)

(72) Inventor: Ryota KIMURA, Osaka (JP)

(73) Assignee: NALUX CO., LTD., Osaka (JP)

(21) Appl. No.: 17/520,992

(22) Filed: Nov. 8, 2021

Related U.S. Application Data
(63) Continuation of application No. PCT/JP2019/035498, filed on Sep. 10, 2019.

(51) Int. Cl. B25J 9/16; G02B 27/62; B25J 9/10

(52) U.S. Cl. CPC B25J 9/1697; B25J 9/10; G02B 27/62

(57) ABSTRACT

An assembling apparatus that is provided with transfer mechanisms in three orthogonal directions and is capable of assembling plural parts with a high degree of accuracy using a holding device attached to one of the transfer mechanisms is provided. The assembling apparatus includes an x-axis transfer mechanism 101; a y-axis transfer mechanism 103; a z-axis transfer mechanism 105; a holding device 107 for holding a work piece, the holding device being attached to the z-axis transfer mechanism such that the holding device is movable in the z-axis direction; a base 1000 having a surface parallel to the x-axis and the y-axis; a first camera 201 attached to the z-axis transfer mechanism such that the optical axis is in the z-axis direction; and a second camera 203 attached to the base such that the optical axis is in the z-axis direction.

### CROSS REFERENCE TO RELATED APPLICATION

This is a Continuation of International Patent Application No. PCT/JP2019/035498 filed Sep. 10, 2019, which designates the U.S. The contents of this application is hereby incorporated by reference.

### TECHNICAL FIELD

The present invention relates to an assembling apparatus and a method for adjusting the same.

### BACKGROUND ART

An assembling apparatus that is provided with transfer mechanisms in three directions orthogonal to one another and that carries out assembling of plural parts using a holding device attached to one of the transfer mechanisms is used. By way of example, such an assembling apparatus is used for assembling of a lens and a lens-barrel. When assembling of a lens and a lens-barrel is carried out, a position of the lens is checked using a camera provided by a holding device, the lens is held by the holding device, the holding device is transferred to a position of the lens-barrel, and the lens is put into the lens-barrel such that the central axis of the lens and that of the lens-barrel agree with each other. If the central axis of the lens and that of the lens-barrel do not agree with each other when the lens is put into the lens-barrel, the inner diameter of the lens-barrel must be greater than the outer diameter of the lens by an amount that depends on a maximum possible value of distance between the central axes. This disadvantageously leads to upsizing of the lens-barrel. In particular, an influence of the distance between the central axes is relatively great when the diameter of the lens is relatively small. For example, when the diameter of the lens is 1 millimeter, the distance between the central axes of 10 micrometers reaches 1% of the diameter. Accordingly, accuracy of alignment of the lens with the lens-barrel adjusted by the holding device should preferably be increased to minimize the above-described distance between the central axes.

Patent document 1 (JP2015530276A) discloses an aligning method of a robot arm using a camera. Patent document 1, however, does not say anything about how a high degree of accuracy is obtained in the aligning method using a camera.

Thus, an assembling apparatus that is provided with transfer mechanisms in three directions orthogonal to one another and that can carry out assembling of plural parts using a holding device attached to one of the transfer mechanisms with a high degree of accuracy and a method for adjusting such an assembling apparatus have not been developed.

### PRIOR ART DOCUMENT

Patent Document
Patent document 1: JP2015530276A

Accordingly, there is a need for an assembling apparatus that is provided with transfer mechanisms in three directions orthogonal to one another and that can carry out assembling of plural parts using a holding device attached to one of the transfer mechanisms with a high degree of accuracy and a method for adjusting such an assembling apparatus. The object of the present invention is to provide an assembling apparatus that is provided with transfer mechanisms in three directions orthogonal to one another and that can carry out assembling of plural parts using a holding device attached to one of the transfer mechanisms with a high degree of accuracy and a method for adjusting such an assembling apparatus.

### SUMMARY OF THE INVENTION

An assembling apparatus according to a first aspect of the present invention includes an x-axis transfer mechanism; a y-axis transfer mechanism; a z-axis transfer mechanism; a holding device for holding a work piece, the holding device being attached to the z-axis transfer mechanism such that the holding device is movable in the z-axis direction; a base having a surface parallel to the x-axis and the y-axis; a first camera attached to the z-axis transfer mechanism such that the optical axis is in the z-axis direction; and a second camera attached to the base such that the optical axis is in the z-axis direction.

By the assembling apparatus according to the present aspect, coordinates of a position of the holding device can be determined with a high degree of accuracy using the first camera and the second camera, and thus assembling of plural parts can be carried out with a high degree of accuracy.

In the assembling apparatus according to a first embodiment of the first aspect of the present invention, each of the first camera and the second camera is configured to rotate around each optical axis.

In the present embodiment, each of the first camera and the second camera is configured to rotate around each optical axis, and thus camera positions can be easily adjusted.

A method for adjusting an assembling apparatus according to a second aspect of the present invention is used for an assembling apparatus provided with an x-axis transfer mechanism; a y-axis transfer mechanism; a z-axis transfer mechanism; a holding device for holding a work piece, the holding device being attached to the z-axis transfer mechanism such that the holding device is movable in the z-axis direction; a base having a surface parallel to the x-axis and the y-axis; a first camera attached to the z-axis transfer mechanism such that the optical axis is in the z-axis direction; and a second camera attached to the base such that the optical axis is in the z-axis direction. The method includes the steps of, adjusting a position of the second camera using an image of the second camera such that transfer of the x-axis transfer mechanism is in the x-axis direction of the image of the second camera, and transfer of the y-axis transfer mechanism is in the y-axis direction of the image of the second camera; placing an alignment mark formed by a first line and a second line that are orthogonal to each other between the first camera and the second camera such that the first and second lines are perpendicular to the z-axis of the assembling apparatus and one of the first and second lines is in one of the x-axis direction and the y-axis direction of the image of the second camera; adjusting a position of the first camera using an image of the first camera such that one of the first and second lines is in one of the x-axis direction and the y-axis direction of the image of the first camera; determining a first set of coordinates of the point of intersection of the first line and the second line with respect to the point of intersection of the x-axis and y-axis of the image of the first camera, using the image of the first camera; determining a second set of coordinates of a reference point of the holding device with respect to the point of intersection of the first line and the second line using the image of the second camera; and determining a third set of coordinates of the reference point of the holding device with respect to the point of intersection of the x-axis and y-axis of the image of the first camera, from the first and second sets of coordinates.

By the method for adjusting the assembling apparatus according to the present aspect, coordinates of a position of the holding device can be determined with a high degree of accuracy using images of the first camera and the second camera, and thus assembling of plural parts can be carried out with a high degree of accuracy.

In the method for adjusting the assembling apparatus according to a first embodiment of the second aspect of the present invention, in the step of adjusting a position of the second camera, a positional relationship between the x-axis and the y-axis of the assembling apparatus is also adjusted.

According to the present embodiment, it is checked whether the x-axis transfer mechanism and the y-axis transfer mechanism are orthogonal to each other, and an angle between the both is adjusted if the both are not orthogonal to each other. Accordingly, errors in coordinates of a position of the reference point of the holding device caused by a state that the x-axis transfer mechanism and the y-axis transfer mechanism are not orthogonal to each other can be reduced.

In the method for adjusting the assembling apparatus according to a second embodiment of the second aspect of the present invention, the step of adjusting a position of the second camera and a positional relationship between the x-axis and the y-axis of the assembling apparatus includes the sub-steps of adjusting a position of the second camera using an image of the second camera such that one of the x-axis transfer mechanism and the y-axis transfer mechanism is made to transfer in the direction of the corresponding axis of the second camera; and adjusting a positional relationship between the x-axis and the y-axis of the assembling apparatus using the image of the second camera such that the other of the x-axis transfer mechanism and the y-axis transfer mechanism is made to transfer in the direction of the corresponding axis of the second camera.

In the method for adjusting the assembling apparatus according to a third embodiment of the second aspect of the present invention, in the step of placing the alignment mark, the alignment mark is placed such that the point of intersection of the first and second lines is made to agree with the point of intersection of the x-axis and y-axis of the image of the second camera.

According to the present embodiment, the image of the second camera can be more easily processed.

In the method for adjusting the assembling apparatus according to a fourth embodiment of the second aspect of the present invention, the x-axis and y-axis of the image of the first camera intersect with each other at the center of the image of the first camera, and the x-axis and y-axis of the image of the second camera intersect with each other at the center of the image of the second camera.

According to the present embodiment, coordinates in images of the cameras are made easier to grasp.

A method for adjusting an assembling apparatus according to a third aspect of the present invention is used for an assembling apparatus provided with an x-axis transfer mechanism; a y-axis transfer mechanism; a z-axis transfer mechanism; a holding device for holding a work piece, the holding device being attached to the z-axis transfer mechanism such that the holding device is movable in the z-axis direction; a base having a surface parallel to the x-axis and the y-axis; a first camera attached to the z-axis transfer mechanism such that the optical axis is in the z-axis direction; and a second camera attached to the base such that the optical axis is in the z-axis direction. The method includes the steps of, transferring the holding device by the x-axis transfer mechanism and the y-axis transfer mechanism such that in an image of the second camera, the point of intersection of the x-axis and the y-axis and a reference point of the holding device are made to agree with each other and storing coordinates of the position after the transfer as (Xc, Yc); transferring the holding device that holds a work piece by the x-axis transfer mechanism and the y-axis transfer mechanism to the coordinates of the position (Xc, Yc), and obtaining coordinates of a reference point of the work piece with respect to the point of intersection of the x-axis and the y-axis in the image of the second camera to obtain differences between the coordinates of the reference point of the holding device and coordinates of the reference point of the work piece.

By the method for adjusting the assembling apparatus according to the present aspect, differences between the coordinates of the reference point of the holding device and coordinates of the reference point of the work piece can be obtained while the holding device holds the work piece, and thus assembling of the work piece and another part can be carried out with a high degree of accuracy.

### BRIEF DESCRIPTION OF DRAWINGS

FIG. 1 shows a perspective view of an assembling apparatus according to an embodiment of the present invention;

FIG. 2 shows a side view of the assembling apparatus according to the embodiment of the present invention;

FIG. 3 shows a cross section containing the central axis of the vacuum chuck;

FIG. 4 is a flowchart for describing a process through which a lens placed on the table is attached to a lens-barrel by the assembling apparatus;

FIG. 5 shows a cross section containing the central axes of the lens and the lens-barrel in the state in which (x, y) coordinates of the center of the chuck are made to agree with (x, y) coordinates of the center of the lens-barrel 600;

FIG. 6 shows a cross section containing the central axis of the lens and the lens-barrel in the state in which the lens has been put into the lens-barrel;

FIG. 7 is a flowchart for describing a method for adjusting the assembling apparatus according to the present invention, by which (x, y) coordinates of the center of the chuck in an image of the first camera are determined;

FIG. 8 is a flowchart for describing step S2010 of FIG. 7;

FIG. 9 shows an example of the alignment mark;

FIG. 10 is a flowchart for describing step S2040 of FIG. 7;

FIG. 11 is a flowchart for describing how (x, y) coordinates of the center of the chuck in an image of the first camera are determined in the conventional assembling apparatus; and

FIG. 12 is a flowchart for describing another method for adjusting the assembling apparatus according to the present invention.

### DESCRIPTION OF EMBODIMENTS

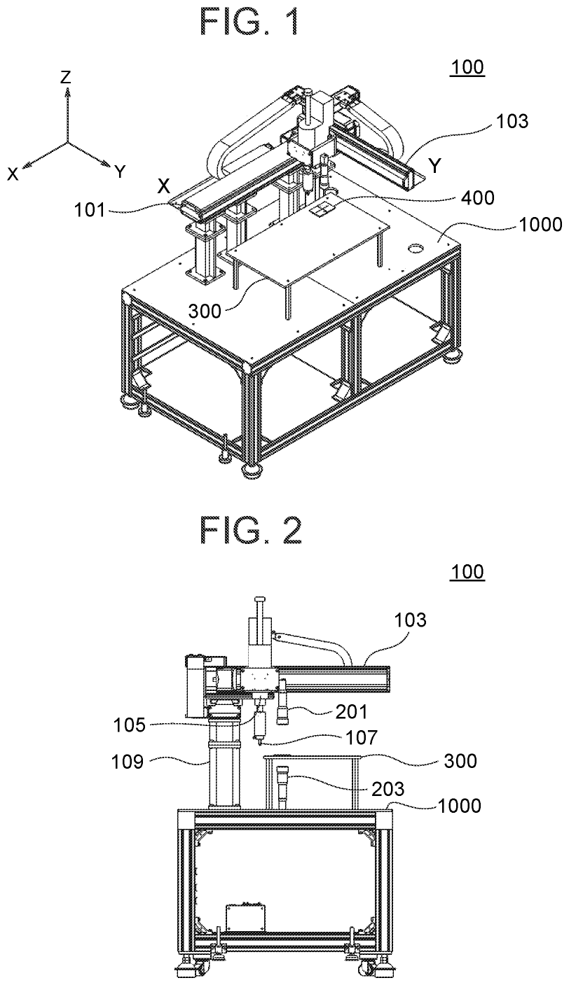

FIG. 1 shows a perspective view of an assembling apparatus 100 according to an embodiment of the present invention.

FIG. 2 shows a side view of the assembling apparatus 100 according to the embodiment of the present invention.

The assembling apparatus 100 is provided with an x-axis transfer mechanism 101 that is a mechanism for transfer in an x-axis direction, a y-axis transfer mechanism 103 that is a mechanism for transfer in a y-axis direction and a z-axis transfer mechanism 105 that is a mechanism for transfer in a z-axis direction. A holding device 107 for holding a work piece is attached to the z-axis transfer mechanism 105 such that the device is movable in the z-axis direction. The transfer in the z-axis direction can be carried out by a cylinder. The z-axis transfer mechanism 105 is attached to the y-axis transfer mechanism 103 such that the z-axis transfer mechanism can transfer in the y-axis direction. The y-axis transfer mechanism 103 is attached to the x-axis transfer mechanism 101 such that the y-axis transfer mechanism can transfer in the x-axis direction. The x-axis transfer mechanism 101 is attached to a base 1000 through spacers 109. On the base 1000, a table 300 on which an object to be transferred is placed. Thus, the holding device 107 can be transferred in the x-axis direction, in the y-axis direction and in the z-axis direction with respect to the base 1000 through the x-axis transfer mechanism 101, the y-axis transfer mechanism 103 and the z-axis transfer mechanism 105. In the description of the present embodiment, the holding device 107 is assumed to be a vacuum chuck.

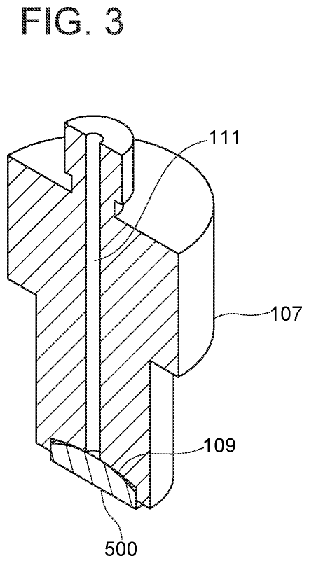

FIG. 3 shows a cross section containing the central axis of the chuck 107. The chuck 107 is provided with a sucking portion 109. Vacuum is made in a space between the sucking portion 109 and a work piece 500 by exhausting air therebetween through an air conduit 111 in order to fix the work piece 500 on the sucking portion 109. As a holding device, another mechanism than a vacuum chuck, for example a mechanical device can be used.

A first camera 201 is attached to a body of the z-axis transfer mechanism 105 such that the optical axis of the first camera 201 is made to be in the z-axis direction. The body of the z-axis transfer mechanism 105 refer to a portion that supports a portion moving in the z-axis direction. A second camera 203 is attached to the base 1000 such that the optical axis of the second camera 203 is made to be in the z-axis direction, and the second camera 203 is substantially opposed to the first camera 201. It is preferable that the attachment of the first camera 201 and the second camera 203 are made such that each camera can be rotated around each optical axis. For example, each camera can be attached onto a rotating stage that is rotatable for adjustment. Further, a tilting stage with which inclination of a surface onto which each camera is attached can be adjusted can be used in a combination with the rotating stage.

By way of example, a process through which a lens 500 placed on the table 300 is attached to a lens-barrel 600 by the assembling apparatus 100 will be described below.

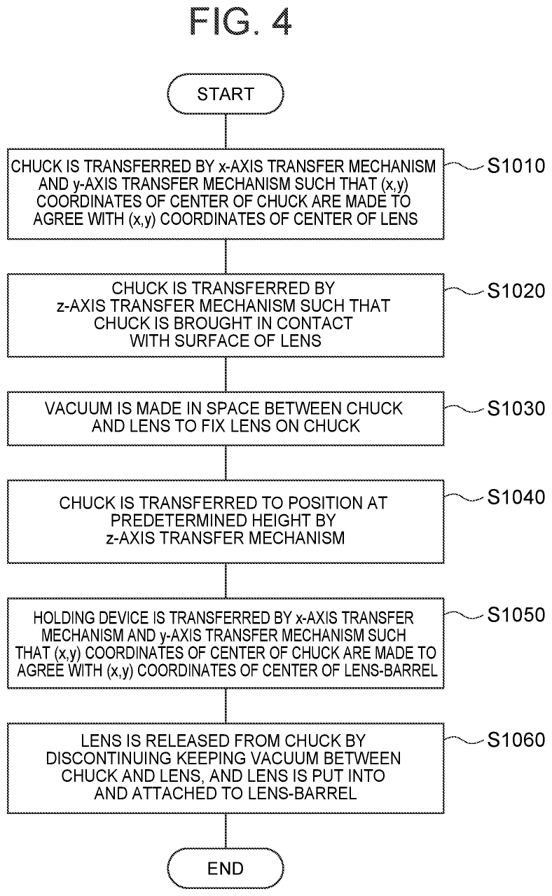

FIG. 4 is a flowchart for describing a process through which a lens 500 placed on the table 300 is attached to a lens-barrel 600 by the assembling apparatus 100.

In step S1010 of FIG. 4, using an image of the first camera 201, the chuck 107 is transferred by the x-axis transfer mechanism 101 and the y-axis transfer mechanism 103 such that (x, y) coordinates of the center of the chuck 107 are made to agree with (x, y) coordinates of the center of the lens 500.

In step S1020 of FIG. 4, the chuck 107 is transferred by the z-axis transfer mechanism 105 such that the chuck 107 is brought in contact with a surface of the lens 500.

In step S1030 of FIG. 4, vacuum is made in a space between the sucking portion 109 of the chuck 107 and the lens 500 to fix the lens 500 on the chuck 107.

In step S1040 of FIG. 4, the chuck 107 is transferred to a position at a predetermined height by the z-axis transfer mechanism 105.

In step S1050 of FIG. 4, using the image of the first camera 201, the chuck 107 is transferred by the x-axis transfer mechanism 101 and the y-axis transfer mechanism 103 such that (x, y) coordinates of the center of the chuck 107 are made to agree with (x, y) coordinates of the center of the lens-barrel 600.

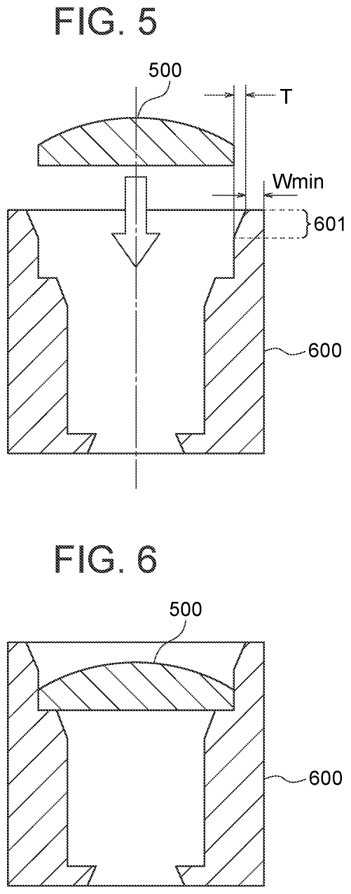

FIG. 5 shows a cross section containing the central axes of the lens 500 and the lens-barrel 600 in the state in which (x, y) coordinates of the center of the chuck 107 agree with (x, y) coordinates of the center of the lens-barrel 600. In FIG. 5, the central axis of the lens 500 and the lens-barrel 600 is represented as an alternate long and short dash line.

In step S1060 of FIG. 4, the lens 500 is released from the chuck 107 by discontinuing keeping a vacuum between the chuck 107 and the lens 500, and the lens 500 is put into the lens-barrel 600. Then, the lens 500 is fixed to the lens-barrel 600 by an adhesive, a screw-type retainer or the like.

FIG. 6 shows a cross section containing the central axis of the lens 500 and the lens-barrel 600 in the state in which the lens 500 has been put into the lens-barrel 600.

In FIG. 5, the central axis of the lens 500 and the central axis of the lens-barrel 600 should preferably agree with each other. As a matter of fact, however, in some cases there exists a predetermined distance between the central axis of the lens 500 and the central axis of the lens-barrel 600. The distance between the central axis of the lens 500 and the central axis of the lens-barrel 600 is referred to as a central axis error in the text of specification. The lens-barrel 600 has a tapered outer wall so as to accommodate the lens 500 even if there exists a central axis error. The minimum inner diameter of a tapered portion 601 of the lens-barrel 600 is equal to the outer diameter of the lens 500. The maximum inner diameter of the tapered portion 601 of the lens-barrel 600 is of the value obtained by adding a value that is twice as great as a maximum possible value T of the central axis error to the above-described minimum inner diameter. On the other hand, the minimum value of the outer wall thickness of the lens-barrel 600 should be equal to or greater than a predetermined value Wmin. A value Db of the outer diameter in a cross section perpendicular to the central axis of the lens-barrel 600 is a sum of the value DI of the outer diameter of the lens 500, the value that is twice as great as the maximum possible value T of the central axis error and the value that is twice as great as the minimum possible value Wmin of the outer wall thickness and can be expressed by the following expression.

Db=Dl+2·T+2·Wmin

Accordingly, the value Db of the outer diameter in a cross section perpendicular to the central axis of the lens-barrel 600 increases with the maximum possible value T of the central axis error, thus disadvantageously leading to upsizing of the lens-barrel.

Causes of the central axis error will be discussed below. In step S1010 of FIG. 4, using an image of the first camera 201, the chuck 107 is transferred such that (x, y) coordinates of the center of the chuck 107 are made to agree with (x, y) coordinates of the center of the lens 500. If the (x, y) coordinates of the center of the chuck 107 agree with the (x, y) coordinates of the center of the lens 500, the central axis of the chuck 107 and the central axis of the lens 500 should agree with each other. Further, in step S1050 of FIG. 4, using the image of the first camera 201, the chuck 107 is transferred such that (x, y) coordinates of the center of the chuck 107 are made to agree with (x, y) coordinates of the center of the lens-barrel 600. If the (x, y) coordinates of the center of the chuck 107 agree with the (x, y) coordinates of the center of the lens-barrel 600, the central axis of the chuck 107 and the central axis of the lens-barrel 600 should agree with each other. In other words, if the (x, y) coordinates of the center of the chuck 107 agree with the (x, coordinates of the center of the lens 500, and the (x, y) coordinates of the center of the chuck 107 agree with the (x, y) coordinates of the center of the lens-barrel 600, the central axis of the lens 500 and the central axis of the lens-barrel 600 should agree with each other, and no central axis error should be generated. Accordingly, a chief cause of the central axis error is considered to be an error in (x, y) coordinates of the center of the chuck 107 in the image of the first camera 201.

A method by which (x, y) coordinates of the center of the chuck 107 in an image of a first camera are determined in a conventional assembling apparatus will be described below. The conventional assembling apparatus is identical with the assembling apparatus described above except that the latter includes the second camera 203, and in the latter the attachment of the first camera 201 is made such that the camera can be rotated around the optical axis.

FIG. 11 is a flowchart for describing how (x, y) coordinates of the center of the chuck 107 in an image of the first camera are determined in the conventional assembling apparatus.

In step S5010 of FIG. 11, using an image of the first camera, coordinates of the center of a lens with respect to the center of the image of the first camera are determined when a chuck is placed at a reference position.

In step S5020 of FIG. 11, the chuck is transferred to the center of the lens such that the central axis of the chuck and the central axis of the lens agree with each other, and differences in coordinates corresponding to the transfer of the chuck are obtained. The agreement between the central axis of the chuck and the central axis of the lens is checked visually, for example.

In step S5030 of FIG. 11, coordinates of the center of the chuck with respect to the center of the image of the first camera are determined from the coordinates of the center of the lens and the differences in coordinates corresponding to the transfer of the chuck.

A method by which (x, y) coordinates of the center of the chuck 107 in an image of the first camera 201 are determined in the assembling apparatus according to the present invention will be described below. The center of the chuck 107 corresponds to the reference point of the holding device described in claims.

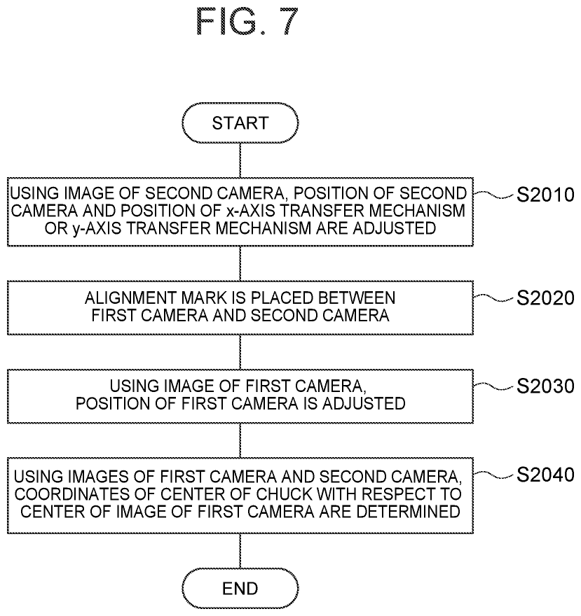

FIG. 7 is a flowchart for describing a method for adjusting the assembling apparatus 100 according to the present invention, by which (x, y) coordinates of the center of the chuck 107 in an image of the first camera 201 are determined.

In step S2010 of FIG. 7, using an image of the second camera 203, a position of the second camera 203 and a position of the x-axis transfer mechanism or the y-axis transfer mechanism are adjusted.

As described above, the first camera 201 is attached to the z-axis transfer mechanism 105 such that the direction of the optical axis is made to agree with the direction of the z-axis. The second camera 203 is attached to the base 1000 such that the direction of the optical axis is made to agree with the direction of the z-axis, and the second camera 203 is substantially opposed to the first camera 201 when the chuck 107 is kept at the reference position. The number of pixels of the first camera 201 and that of the second camera 203 are, by way of example, 4000 by 3000 (=12 M). Assuming that the pixel resolution is 5 micrometers, a field of view of each camera is 20.0 mm by 15.0.

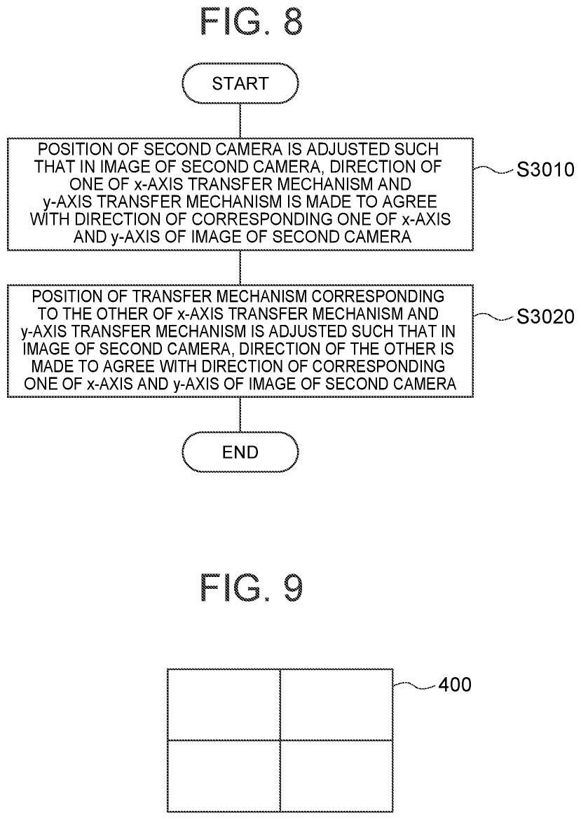

FIG. 8 is a flowchart for describing step S2010 of FIG. 7.

In step S3010 of FIG. 8, a position of the second camera 203 is adjusted such that in an image of the second camera 203, the direction of one of the x-axis and the y-axis of the assembling apparatus 100 is made to agree with the direction of the corresponding one of the x-axis and the y-axis of the image of the second camera 203. More specifically, a position of the second camera 203 can be adjusted by rotating it around the central axis using the rotating stage such that when the chuck 107 is made to transfer by one of the x-axis transfer mechanism and the y-axis transfer mechanism, the direction of transfer of the chuck 107 is made to agree with the direction of the corresponding one of the x-axis and the y-axis in the image of the second camera 203.

The x-axis and the y-axis of an image of a camera are defined in two directions that are perpendicular to the optical axis of the camera and are orthogonal to each other. The x-axis and the y-axis are determined such that the axes intersect each other on the optical axis of the camera. Accordingly, the point of intersection of the x-axis and the y-axis is located at the center of the image. (x, y) coordinates of an image of the camera are determined according to the x-axis and the y-axis of the image of the camera.

In step S3020 of FIG. 8, a position of the transfer mechanism corresponding to the other of the x-axis and the y-axis is adjusted such that the direction of the other of the x-axis and the y-axis of the assembling apparatus 100 is made to agree with that the direction of the corresponding one of the x-axis and the y-axis in the image of the second camera 203. In the present step, it is checked that the x-axis transfer mechanism 101 and the y-axis transfer mechanism 103 are orthogonal to each other. If they are not orthogonal to each other, an angle between the both is adjusted such that the both are made orthogonal to each other. A screw or a shim for angle adjustment can be provided in advance.

In step S2020 of FIG. 7, an alignment mark 400 is placed between the first camera 201 and the second camera 203.

FIG. 9 shows an example of the alignment mark 400. The alignment mark 400 of the present example is formed by two lines that are orthogonal to each other and marked on a transparent plate. The plate with the alignment mark 400 can be attached to the table 300 as shown in FIG. 1. The plate with the alignment mark 400 is located such that the plate is made to be parallel to the x-axis and the y-axis of the assembling apparatus 100, and the alignment mark 400 is within the field of view of the first camera 201 attached to the z-axis transfer mechanism 105 and within the field of view of the second camera 203 attached to the base 1000. Further, the plate with the alignment mark 400 is located such that in an image of the second camera 203, the point of intersection of the two lines that are orthogonal to each other of the alignment mark 400 is made to agree with the center of the image, and one of the two lines described above is made to agree with the x-axis or the y-axis of the image of the second camera 203.

The first camera 201 and the second camera 203 are made to focus on the position of the alignment mark 400.

In step S2030 of FIG. 7, using an image of the first camera 201, a position of the first camera 201 is adjusted. More specifically, the first camera 201 is rotated around the optical axis using the rotating stage or the like such that in an image of the first camera 201, one of the x-axis and the y-axis of the image is made to agree with the corresponding line of the alignment mark 400.

In step S2040 of FIG. 7, using the images of the first camera 201 and the second camera 203, coordinates of the center of the chuck with respect to the center of the image of the first camera 201 are obtained.

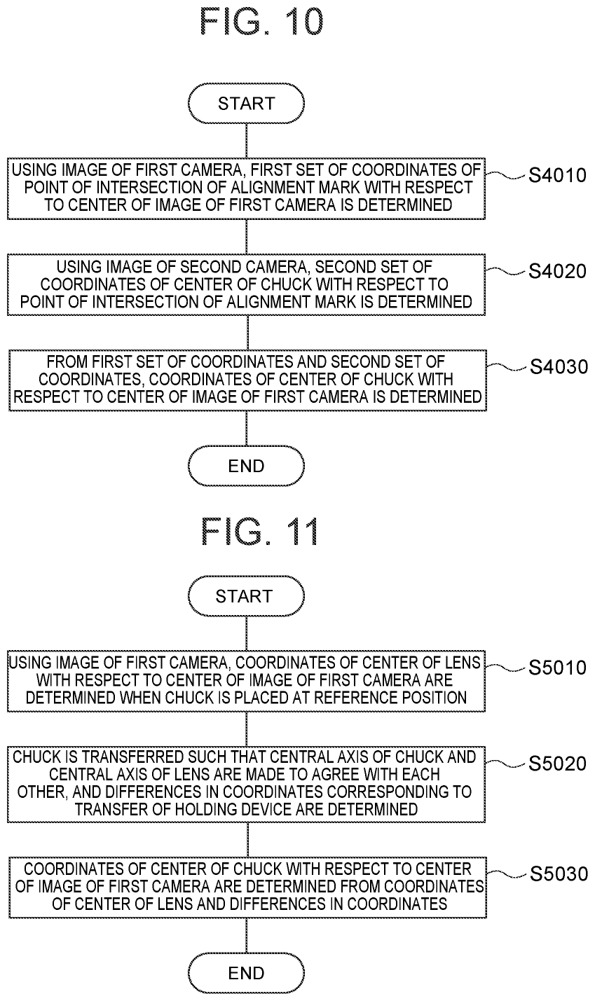

FIG. 10 is a flowchart for describing step S2040 of FIG. 7.

In step S4010 of FIG. 10, using the image of the first camera 201, a first set of coordinates of the point of intersection of the alignment mark 400 with respect to the center of the image of the first camera 201 is determined.

In step S4020 of FIG. 10, using the image of the second camera 203, a second set of coordinates of the center of the chuck 107 with respect to the center of the image of the second camera 203 is determined.

In step S4030 of FIG. 10, from the first set of coordinates and the second set of coordinates, coordinates of the center of the chuck 107 with respect to the center of the image of the first camera 201 is determined.

When the lens 500 is attached to the lens-barrel 600 after coordinates of the center of the chuck 107 have been determined by the adjusting method shown in FIG. 7, assembling can be carried out with a high degree of accuracy.

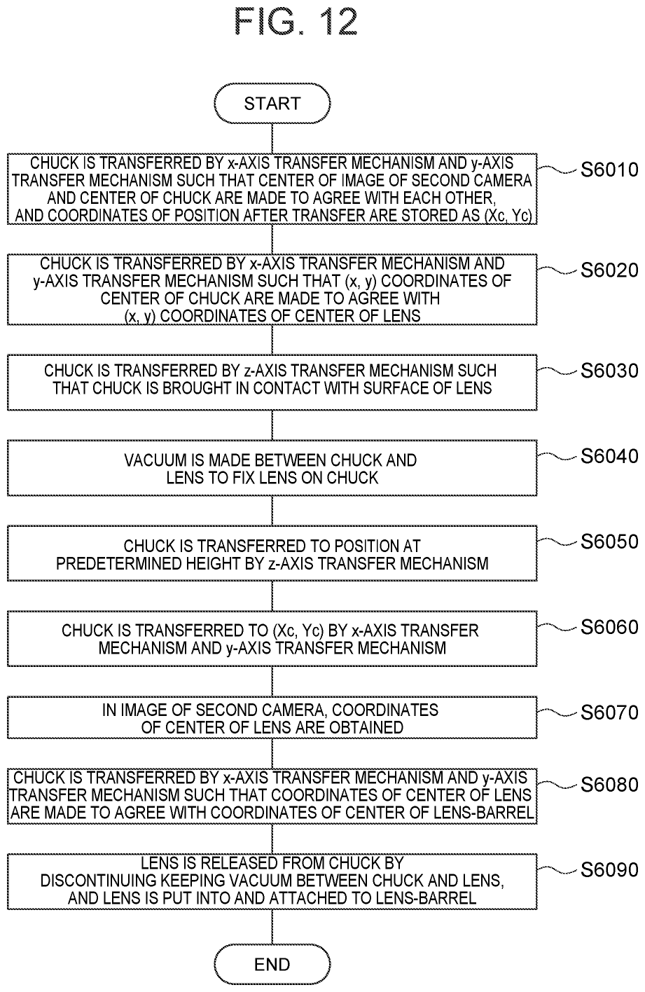

FIG. 12 is a flowchart for describing another method for adjusting the assembling apparatus 100 according to the present invention. In the present adjusting method, coordinates of the center of the lens 500 that is the work piece are determined in the procedure shown in the flowchart of FIG. 4. Steps S6020-S6050 in the flowchart of FIG. 12 correspond to steps S1010-S1040 in the flowchart of FIG. 4, and step S6090 in the flowchart of FIG. 12 corresponds to step S1060 in the flowchart of FIG. 4.

In step S6010 of FIG. 12, the chuck 107 is transferred by the x-axis transfer mechanism 101 and the y-axis transfer mechanism 103 such that in an image of the second camera 203, the center of the image and the center of the chuck are made to agree with each other. Coordinates of the position after the transfer are stored as (Xc, Yc). The coordinates of the position are those indicating the position of the x-axis transfer mechanism 101 and the position of the y-axis transfer mechanism 103. The center of the image is the point of intersection of the x-axis and the y-axis of the image.

In step S6020 of FIG. 12, using an image of the first camera 201, the chuck 107 is transferred by the x-axis transfer mechanism 101 and the y-axis transfer mechanism 103 such that (x, y) coordinates of the center of the chuck 107 are made to agree with (x, y) coordinates of the center of the lens 500.

In step S6030 of FIG. 12, the chuck 107 is transferred by the z-axis transfer mechanism 105 such that the chuck 107 is brought in contact with a surface of the lens 500.

In step S6040 of FIG. 12, vacuum is made in a space between the sucking portion 109 of the chuck 107 and the lens 500 to fix the lens 500 on the chuck 107.

In step S6050 of FIG. 12, the chuck 107 is transferred to a position at a predetermined height by the z-axis transfer mechanism 105.

In step S6060 of FIG. 12, the chuck 107 is transferred to the coordinates of the position (Xc, Yc) by the x-axis transfer mechanism 101 and the y-axis transfer mechanism 103.

In step S6070 of FIG. 12, in the image of the second camera 203, coordinates of the center of the lens 500 are obtained. Since at the coordinates of the position (Xc, Yc), the center of the chuck 107 agrees with the center of the image of the second camera 203, the coordinates of the center of the lens 500 described above with respect to the center of the image of the second camera 203 correspond to differences between the coordinates of the center of the chuck 107 and the coordinates of the center of the lens 500.

In step S6080 of FIG. 12, the chuck 107 is transferred by the x-axis transfer mechanism 101 and the y-axis transfer mechanism 103 such that using the image of the first camera 201, (x, y) coordinates of the center of the lens 500 are made to agree with (x, y) coordinates of the center of the lens-barrel 600. For the transfer, the (x, y) coordinates of the center of the lens 500 can be determined with a high degree of accuracy using the above-described differences between the coordinates.

In step S6090 of FIG. 12, the lens 500 is released from the chuck 107 by discontinuing keeping a vacuum between the chuck 107 and the lens 500, and the lens 500 is put into the lens-barrel 600. Then the lens 500 is fixed to the lens-barrel 600 by an adhesive, a screw-type retainer or the like.

Since differences between the coordinates of the center of the chuck and the coordinates of the center of the lens can be obtained by the adjusting method shown in FIG. 12, the central axis of the lens and the central axis of the lens-barrel can be aligned with a high degree of accuracy even if the central axis of the lens and the central axis of the lens do not agree with each other when the chuck holds the lens.

According to a method of the present invention, a maximum possible value T of the central axis error can be reduced by several tens micrometers compared with in a conventional method. When the diameter of the lens 500 is 1-2 millimeters, the diameter of the lens-barrel 600 can be reduced by several percent.

What is claimed is:

1. An assembling apparatus comprising:
an x-axis transfer mechanism;
a y-axis transfer mechanism;
a z-axis transfer mechanism;
a holding device for holding a work piece, the holding device being attached to the z-axis transfer mechanism such that the holding device is movable in the z-axis direction;
a base having a surface parallel to the x-axis and the y-axis;
a first camera attached to the z-axis transfer mechanism such that the optical axis is in the z-axis direction; and
a second camera attached to the base such that the optical axis is in the z-axis direction,
wherein each of the first camera and the second camera is configured to rotate around each optical axis.

2. The assembling apparatus according to claim 1, wherein a surface onto which each of the first camera and the second camera is attached is configured such that inclination of the surface can be adjusted.

3. A method for adjusting an assembling apparatus comprising:
an x-axis transfer mechanism;
a y-axis transfer mechanism;
a z-axis transfer mechanism;
a holding device for holding a work piece, the holding device being attached to the z-axis transfer mechanism such that the holding device is movable in the z-axis direction;
a base having a surface parallel to the x-axis and the y-axis;
a first camera attached to the z-axis transfer mechanism such that the optical axis is in the z-axis direction; and
a second camera attached to the base such that the optical axis is in the z-axis direction, the method comprising the steps of,
adjusting a position of the second camera using an image of the second camera such that transfer of the x-axis transfer mechanism is in the x-axis direction of the image of the second camera, and transfer of the y-axis transfer mechanism is in the y-axis direction of the image of the second camera;
placing an alignment mark formed by a first line and a second line that are orthogonal to each other between the first camera and the second camera such that the first and second lines are perpendicular to the z-axis of the assembling apparatus and one of the first and second lines is in one of the x-axis direction and the y-axis direction of the image of the second camera;
adjusting a position of the first camera using an image of the first camera such that one of the first and second lines is in one of the x-axis direction and the y-axis direction of the image of the first camera;
determining a first set of coordinates of the point of intersection of the first line and the second line with respect to the point of intersection of the x-axis and y-axis of the image of the first camera, using the image of the first camera;
determining a second set of coordinates of a reference point of the holding device with respect to the point of intersection of the first line and the second line using the image of the second camera; and
determining a third set of coordinates of the reference point of the holding device with respect to the point of intersection of the x-axis and y-axis of the image of the first camera, from the first and second sets of coordinates.

4. The method for adjusting the assembling apparatus according to claim 3, wherein in the step of adjusting a position of the second camera, a positional relationship between the x-axis and the y-axis of the assembling apparatus is also adjusted.

5. The method for adjusting the assembling apparatus according to claim 4, wherein the step of adjusting a position of the second camera and a positional relationship between the x-axis and the y-axis of the assembling apparatus comprises the sub-steps of:
adjusting a position of the second camera using an image of the second camera such that one of the x-axis transfer mechanism and the y-axis transfer mechanism is made to transfer in the direction of the corresponding axis of the second camera; and
adjusting a positional relationship between the x-axis and the y-axis of the assembling apparatus using the image of the second camera such that the other of the x-axis transfer mechanism and the y-axis transfer mechanism is made to transfer in the direction of the corresponding axis of the second camera.

6. The method for adjusting the assembling apparatus according to claim 3, wherein in the step of placing the alignment mark, the alignment mark is placed such that the point of intersection of the first and second lines is made to agree with the point of intersection of the x-axis and the y-axis of the image of the second camera.

7. The method for adjusting the assembling apparatus according to claim 3, wherein the x-axis and y-axis of the image of the first camera intersect with each other at the center of the image of the first camera, and the x-axis and y-axis of the image of the second camera intersect with each other at the center of the image of the second camera.
